(19) United States
(12) Patent Application Publication
(10) Pub. No.: US 2025/0231131 A1
(43) Pub. Date: Jul. 17, 2025

(54) IMAGING SYSTEMS WITH SMALL X-RAY SOURCES

(71) Applicant: SHENZHEN XPECTVISION TECHNOLOGY CO., LTD., Guangdong (CN)

(72) Inventor: Yurun LIU, Guangdong (CN)

(73) Assignee: SHENZHEN XPECTVISION TECHNOLOGY CO., LTD., Guangdong (CN)

(21) Appl. No.: 19/096,770

(22) Filed: Apr. 1, 2025

Related U.S. Application Data
(63) Continuation of application No. PCT/CN2023/116879, filed on Sep. 5, 2023.

(51) Int. Cl. G01N 23/2252

(52) U.S. Cl. CPC G01N 23/2252; G01N 2223/079; G01N 2223/427; G01N 2223/615

(57) ABSTRACT

A system for generating X-rays includes an electron source that generates an electron beam, a support layer with multiple holes and a target layer on the support layer and having target regions respectively over the holes. The electron source can direct the electron beam at the target regions one at a time to generate X-rays from the target regions, while the electron beam goes through the support layer via the holes without hitting any portion of the support layer. Another system for generating X-rays includes an electron source that generates an electron beam; a support layer with multiple support regions; a target layer on the support layer and having target regions respectively over the support regions; and an X-ray detector. The X-ray detector can capture an image of an object using the target X-rays but not using the support X-rays.

### CROSS-REFERENCE TO RELATED APPLICATION

This application is a continuation of international PCT application serial no. PCT/CN2023/116879, filed on Sep. 5, 2023. The entirety of the above-mentioned patent application is hereby incorporated by reference herein and made a part of this specification.

### BACKGROUND

An imaging system can include an electron source, a target layer, and an X-ray detector. The object to be imaged can be positioned between the target layer and the X-ray detector. The electron source can send an electron beam toward a target region of the target layer, thereby generating X-rays from the target region. The X-ray detector can capture an image of the object based on the interaction between the X-rays and the object.

### SUMMARY

Disclosed herein is a system, comprising: an electron source configured to generate an electron beam; a support layer comprising M holes (holes (i), i=1, . . . , M), with M being a positive integer; and a target layer (A) on the support layer, and (B) comprising M target regions (target regions (i), i=1, . . . , M). For each value of i and one value of i at a time, the electron source is configured to direct the electron beam at the target region (i), thereby causing the target region (i) to generate X-rays (i) from the target region (i), while the electron beam goes through the support layer via the hole (i) without hitting any portion of the support layer.

In an aspect, the system further comprises an X-ray detector. For each value of i, the X-ray detector is configured to capture an image (i) of a same object based on an interaction between the X-rays (i) and the object.

In an aspect, M>1.

In an aspect, the target layer comprises platinum, tungsten, copper, or a combination thereof.

In an aspect, the target layer comprises carbon, beryllium, or a combination thereof.

In an aspect, a thickness of the target layer measured in a direction perpendicular to the target layer is less than a mean free path of electrons of the electron beam in the target layer. In an aspect, the support layer comprises silicon.

In an aspect, the target layer is in direct physical contact with the support layer.

Disclosed herein is a method of using the system above. The method comprising, for each value of i and one value of i at a time: directing the electron beam at the target region (i), thereby causing the target region (i) to generate the X-rays (i) from the target region (i); and capturing with a same X-ray detector an image (i) of a same object based on an interaction between the X-rays (i) and the object, while the electron beam goes through the support layer via the hole (i) without hitting any portion of the support layer.

Disclosed herein is a system, comprising: an electron source configured to generate an electron beam; a support layer comprising M support regions (support regions (i), i=1, . . . , M), with M being a positive integer; a target layer (A) on the support layer, and (B) comprising M target regions (target regions (i), i=1, . . . , M); and an X-ray detector. For each value of i and one value of i at a time, the electron source is configured to direct the electron beam simultaneously at (A) the target region (i), thereby causing the target region (i) to generate target X-rays (i) from the target region (i), and (B) the support region (i), thereby causing the support region (i) to generate support X-rays (i) from the support region (i), and the X-ray detector is configured to capture an image (i) of a same object (A) based on an interaction between the target X-rays (i) and the object and (B) not based on any interaction between the support X-rays (i) and the object.

In an aspect, the X-ray detector is configured to not detect the support X-rays (i), i=1, . . . , M.

In an aspect, the system further comprises a filter layer (A) positioned between the support layer and the X-ray detector and (B) configured to block the support X-rays (i), i=1, . . . , M.

In an aspect, the system further comprises a filter layer (A) positioned between (i) a combination of the target layer and the support layer, and (ii) the X-ray detector, and (B) configured to attenuate the target X-rays (i), i=1, . . . , M and the support X-rays (i), i=1, . . . , M by different degrees.

In an aspect, the system further comprises a grating (A) positioned between (i) a combination of the target layer and the support layer, and (ii) the X-ray detector, (B) configured to aim the target X-rays (i), i=1, . . . , M at the X-ray detector, and (C) configured to aim the support X-rays (i), i=1, . . . , M not at the X-ray detector.

In an aspect, the support layer is configured to block a wavelength range of the target X-rays (i), i=1, . . . , M.

In an aspect, (A) the target layer comprises platinum, and the support layer comprises aluminum, or (B) the target layer comprises copper, and the support layer comprises nickel.

In an aspect, the target layer comprises a polymer.

In an aspect, a thickness of the target layer measured in a direction perpendicular to the target layer is less than a mean free path of electrons of the electron beam in the target layer.

In an aspect, the target layer is in direct physical contact with the support layer.

Disclosed herein is a method of using the system above. The method comprises, for each value of i and one value of i at a time: directing the electron beam at the target region (i), thereby causing the target region (i) to generate the target X-rays (i) from the target region (i); and capturing with the X-ray detector the image (i) of the object based on an interaction between the target X-rays (i) and the object.

### BRIEF DESCRIPTION OF FIGURES

FIG. 1 schematically shows an imaging system, according to an embodiment.

FIG. 2 and FIG. 3 show the target structure of the imaging system of FIG. 1, according to an embodiment.

FIG. 4 shows a flowchart generalizing the operation of the imaging system of FIG. 1, according to an embodiment.

FIG. 5 schematically shows an imaging system, according to an alternative embodiment.

FIG. 6 shows a flowchart generalizing the operation of the imaging system of FIG. 5, according to an embodiment.

FIG. 7 and FIG. 8 schematically show the imaging system of FIG. 5, according to alternative embodiments.

### DETAILED DESCRIPTION

### Imaging System 100

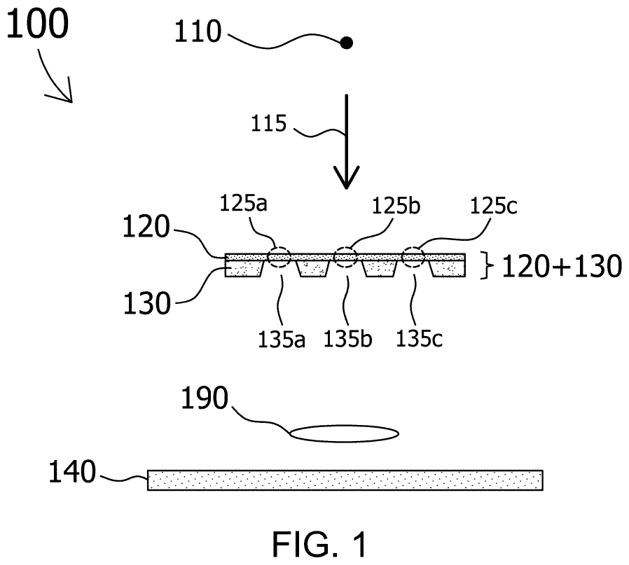

FIG. 1 schematically shows an imaging system 100, according to an embodiment. In an embodiment, the imaging system 100 may include an electron source 110, a target structure 120+130, and an X-ray detector 140.

### Electron Source 110

In an embodiment, the electron source 110 may generate an electron beam 115 toward the target structure 120+130. In an embodiment, the electron beam 115 may be a pencil beam. The electron source 110 may have any suitable structure. For example, the electron source 110 may a thermionic source or a field emission source. The electron source 110 may include electron optics that guide and shape the electron beam 115.

### Target Structure 120+130

In an embodiment, the target structure 120+130 may include a target layer 120 and a support layer 130.

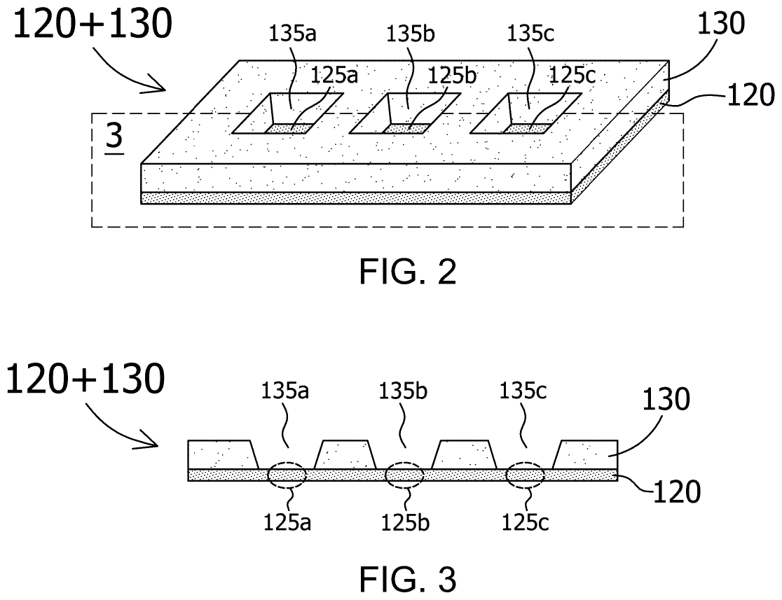

FIG. 2 shows a perspective view of the target structure 120+130 of FIG. 1, according to an embodiment. FIG. 3 shows a cross-sectional view of the target structure 120+130 of FIG. 2 along a plane 3.

In an embodiment, with reference to FIG. 1, the target layer 120 may be on the support layer 130. In an embodiment, the target layer 120 may be in direct physical contact with the support layer 130.

In an embodiment, the target layer 120 may be between the electron source 110 and the support layer 130 (as shown in FIG. 1). In an alternative embodiment, the support layer 130 may be between the electron source 110 and the target layer 120 (i.e., the target structure 120+130 of FIG. 1 is turned upside down as shown in FIG. 2 and FIG. 3).

In an embodiment, the chemical composition of the target layer 120 may be different from the chemical composition of the support layer 130.

### Target Layer 120

In an embodiment, with reference to FIG. 1-FIG. 3, the target layer 120 may include one or more target regions 125 (e.g., target regions 125a, 125b, and 125c).

In an embodiment, the target layer 120 may include heavy element(s) such as platinum, tungsten, copper, or a combination thereof. In an embodiment, the target layer 120 may further include support element(s) such as carbon, beryllium, or a combination thereof. For example, the target layer 120 may be a film of the heavy element (e.g., a film of platinum). For example, the target layer 120 may be a film of the support element (e.g., a film of carbon or beryllium) with the heavy element on or in it.

In an embodiment, the thickness of the target layer 120 measured in a direction perpendicular to the target layer 120 may be less than the mean free path of electrons of the electron beam 115 in the target layer 120. As a result, when an electron of the electron beam 115 enters the target layer 120, it is likely that the electron would either (A) go through the target layer 120 without hitting any atom of the target layer 120, or (B) hit only one atom of the target layer 120 and thereby causing X-rays to be generated from the atom. This means that it is not likely the electron would scatter around inside the target layer 120 by hitting multiple atoms and thereby causing X-rays to be generated from multiple atoms.

### Support Layer 130

In an embodiment, with reference to FIG. 1-FIG. 3, the support layer 130 may include one or more holes 135 corresponding one-to-one to the target regions 125 (e.g., 3 holes 135a, 135b, and 135c). In an embodiment, the target regions 125a, 125b, and 125c may be respectively on and over the holes 135a, 135b, and 135c (as shown). In an embodiment, the holes 135 are through holes (i.e., the holes 135 are through the entire thickness of the support layer 130). In an embodiment, the holes 135 are blind holes (i.e., the holes 135 are not through the entire thickness of the support layer 130).

In an embodiment, the support layer 130 may include silicon. For example, the target layer 120 may be formed on the support layer 130 before the holes 135 are formed (e.g., by etching silicon).

In an embodiment, the support layer 130 may be electrically conductive. As a result, the support layer 130 can provide a path for electrons accumulated in the target layer 120 (due to electron bombardment) to drain to electric ground.

### Object 190

In an embodiment, with reference to FIG. 1, an object 190 may be positioned between the target structure 120+130 and the X-ray detector 140 (as shown).

### Operation of Imaging System 100

In an embodiment, with reference to FIG. 1, the imaging system 100 may operate as follows.

In an embodiment, the electron beam 115 may be directed at the target region 125a, thereby causing the target region 125a to generate first X-rays (not shown) from the target region 125a while the electron beam 115 goes through the support layer 130 via the hole 135a without hitting any portion of the support layer 130. In an embodiment, the X-ray detector 140 may capture a first image of the object 190 based on the interaction between the first X-rays and the object 190.

The interaction between the first X-rays and the object 190 may include scenarios such as: (A) some of the radiation particles of the first X-rays that are incident on the object 190 are blocked by the object 190, and (B) some of the radiation particles of the first X-rays that are incident on the object 190 travel through the object 190 without changing their directions.

In an embodiment, after the X-ray detector 140 captures the first image of the object 190, the electron beam 115 may be directed at the target region 125b, thereby causing the target region 125b to generate second X-rays (not shown) from the target region 125b while the electron beam 115 goes through the support layer 130 via the hole 135b without hitting any portion of the support layer 130. In an embodiment, the X-ray detector 140 may capture a second image of the object 190 based on the interaction between the second X-rays and the object 190.

In an embodiment, after the X-ray detector 140 captures the second image of the object 190, the electron beam 115 may be directed at the target region 125c, thereby causing the target region 125c to generate third X-rays (not shown) from the target region 125c while the electron beam 115 goes through the support layer 130 via the hole 135c without hitting any portion of the support layer 130. In an embodiment, the X-ray detector 140 may capture a third image of the object 190 based on the interaction between the third X-rays and the object 190.

### Flowchart Generalizing Operation of Imaging System 100

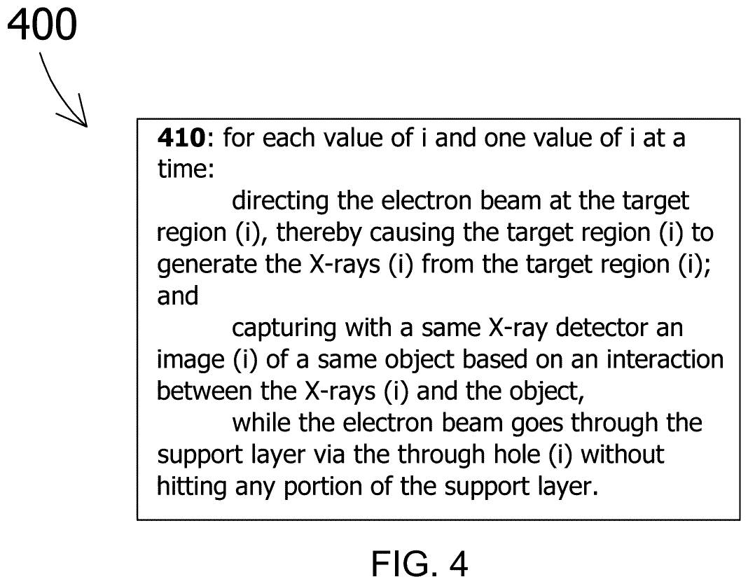

FIG. 4 shows a flowchart 400 generalizing the operation of the imaging system 100 of FIG. 1, according to an embodiment.

In step 410, the operation may include, for each value of i and one value of i at a time: directing the electron beam at the target region (i), thereby causing the target region (i) to generate the X-rays (i) from the target region (i); and capturing with a same X-ray detector an image (i) of a same object based on an interaction between the X-rays (i) and the object, while the electron beam goes through the support layer via the hole (i) without hitting any portion of the support layer. For example, in the embodiments described above, with reference to FIG. 1, for the first image of the object 190, the electron beam 115 is directed at the target region 125a, thereby causing the target region 125a to generate the first X-rays from the target region 125a, and the X-ray detector 140 captures the first image of the object 190 based on the interaction between the first X-rays and the object 190, while the electron beam 115 goes through the support layer 130 via the hole 135a without hitting any portion of the support layer 130. Then, the second image of the object 190 and then the third image of the object 190 are captured in a similar manner.

### Imaging System 500

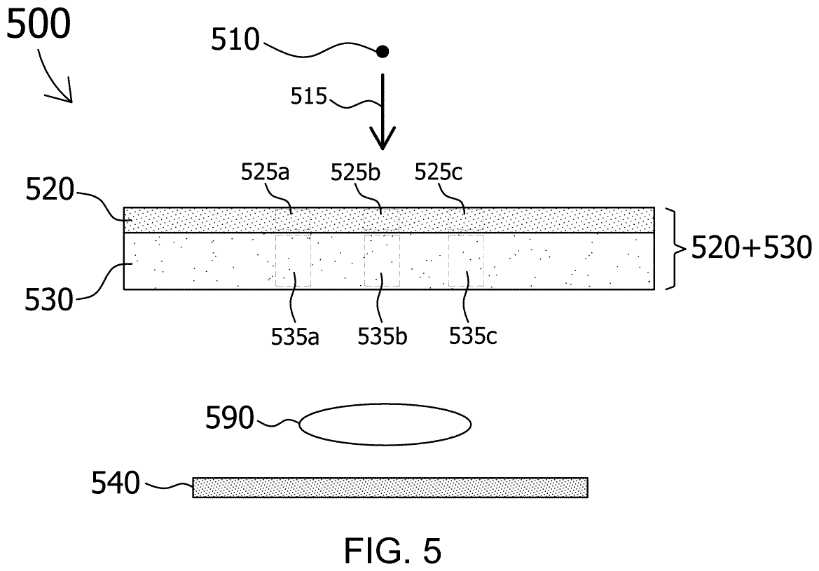

FIG. 5 schematically shows an imaging system 500, according to an embodiment. In an embodiment, the imaging system 500 may include an electron source 510, a target structure 520+530, and an X-ray detector 540.

### Electron Source 510

In an embodiment, with reference to FIG. 5, the electron source 510 may generate an electron beam 515 toward the target structure 520+530. In an embodiment, the electron beam 515 may be a pencil beam. In an embodiment, the electron beam 515 may be focused onto a spot on the target structure 520+530.

### Target Structure 520+530

In an embodiment, with reference to FIG. 5, the target structure 520+530 may include a target layer 520 and a support layer 530. In an embodiment, the target layer 520 may be on the support layer 530 as shown. In an embodiment, the target layer 520 may be in direct physical contact with the support layer 530.

In an embodiment, the target layer 520 may be between the electron source 510 and the support layer 530 (as shown).

In an embodiment, the chemical composition of the target layer 520 may be different from the chemical composition of the support layer 530.

In an embodiment, the target layer 520 may include platinum; and the support layer 530 may include aluminum. Alternatively, the target layer 520 may include copper; and the support layer 530 may include nickel. In an embodiment, the target layer 520 may include a polymer.

### Target Layer 520

In an embodiment, with reference to FIG. 5, the target layer 520 may include one or more target regions 525 (e.g., target regions 525a, 525b, and 525c).

In an embodiment, the thickness of the target layer 520 measured in a direction perpendicular to the target layer 520 may be less than the mean free path of electrons of the electron beam 515 in the target layer 520.

### Support Layer 530

In an embodiment, with reference to FIG. 5, the support layer 530 may include one or more support regions 535 corresponding one-to-one to the target regions 525 (e.g., support regions 535a, 535b, and 535c).

### Object 590

In an embodiment, with reference to FIG. 5, an object 590 may be positioned between the target structure 520+530 and the X-ray detector 540 (as shown).

### Operation of Imaging System 500

In an embodiment, with reference to FIG. 5, the imaging system 500 may operate as follows.

In an embodiment, the electron beam 515 may be directed simultaneously at (A) the target region 525a, thereby causing the target region 525a to generate first target X-rays (not shown) from the target region 525a, and (B) the support region 535a, thereby causing the support region 535a to generate first support X-rays (not shown) from the support region 535a. The electron beam 515 may be directed simultaneously at the target region 525a and the support region 535a because the electron beam 515 may penetrate the target region 525a. In an embodiment, the X-ray detector 540 may capture a first image of the object 590 (A) based on the interaction between the first target X-rays and the object 590 and (B) not based on any interaction between the first support X-rays and the object 590.

In an embodiment, after the X-ray detector 540 captures the first image of the object 590, the electron beam 515 may be directed simultaneously at (A) the target region 525b, thereby causing the target region 525b to generate second target X-rays (not shown) from the target region 525b, and (B) the support region 535b, thereby causing the support region 535b to generate second support X-rays (not shown) from the support region 535b. In an embodiment, the X-ray detector 540 may capture a second image of the object 590 (A) based on the interaction between the second target X-rays and the object 590 and (B) not based on any interaction between the second support X-rays and the object 590.

In an embodiment, after the X-ray detector 540 captures the second image of the object 590, the electron beam 515 may be directed simultaneously at (A) the target region 525c, thereby causing the target region 525c to generate third target X-rays (not shown) from the target region 525c, and (B) the support region 535c, thereby causing the support region 535c to generate third support X-rays (not shown) from the support region 535c. In an embodiment, the X-ray detector 540 may capture a third image of the object 590 (A) based on the interaction between the third target X-rays and the object 590 and (B) not based on any interaction between the third support X-rays and the object 590.

### Flowchart Generalizing Operation of Imaging System 500

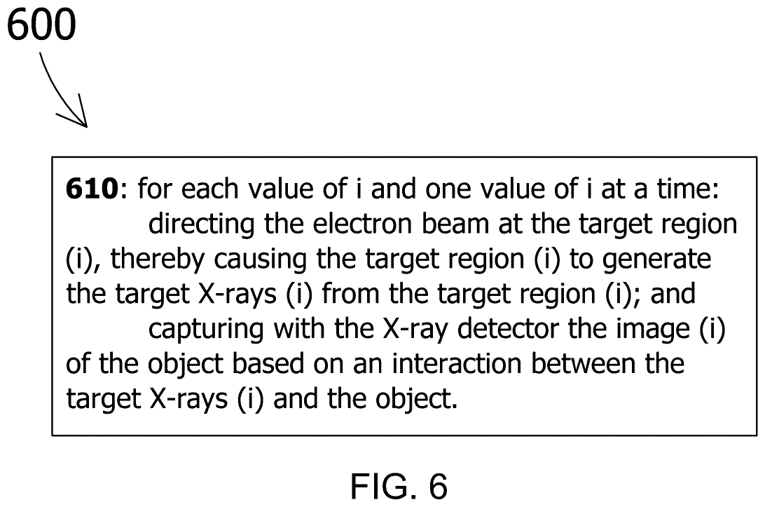

FIG. 6 shows a flowchart 600 generalizing the operation of the imaging system 500 of FIG. 5, according to an embodiment.

In step 610, the operation may include, for each value of i and one value of i at a time: directing the electron beam at the target region (i), thereby causing the target region (i) to generate the target X-rays (i) from the target region (i); and capturing with the X-ray detector the image (i) of the object based on an interaction between the target X-rays (i) and the object. For example, in the embodiments described above, with reference to FIG. 5, for the first image of the object 590, the electron beam 515 is directed at the target region 525a, thereby causing the target region 525a to generate the first target X-rays from the target region 525a; and the X-ray detector 540 captures the first image of the object 590 based on the interaction between the first target X-rays and the object 590. Then, the second image of the object 590 and then the third image of the object 590 are captured in a similar manner.

### Other Embodiments for Imaging System 500

### Support Layer 530 Blocks a Wavelength Range

In an embodiment, with reference to FIG. 5, the support layer 530 may block a wavelength range of the first, second, and third target X-rays. For example, the material of the support layer 530 may be such that radiation particles of the first, second, and third target X-rays having wavelengths greater than a pre-specified wavelength are blocked by the support layer 530.

### X-Ray Detector 540 Does Not Detect Support X-Rays

In an embodiment, with reference to FIG. 5, the X-ray detector 540 may not detect the first, second, and third support X-rays. As a result, the first, second, and third images of the object 590 are captured by the X-ray detector 540 not based on any interaction between the first, second, and third support X-rays and the object 590. Specifically, the first image of the object 590 is captured by the X-ray detector 540 not based on any interaction between the first support X-rays and the object 590. Similarly, the second image of the object 590 is captured by the X-ray detector 540 not based on any interaction between the second support X-rays and the object 590. Similarly, the third image of the object 590 is captured by the X-ray detector 540 not based on any interaction between the third support X-rays and the object 590.

Note that the phrase “not detect” above means the X-ray detector 540 receives but disregards the radiation particles of the first, second, and third support X-rays.

### Filter Layer

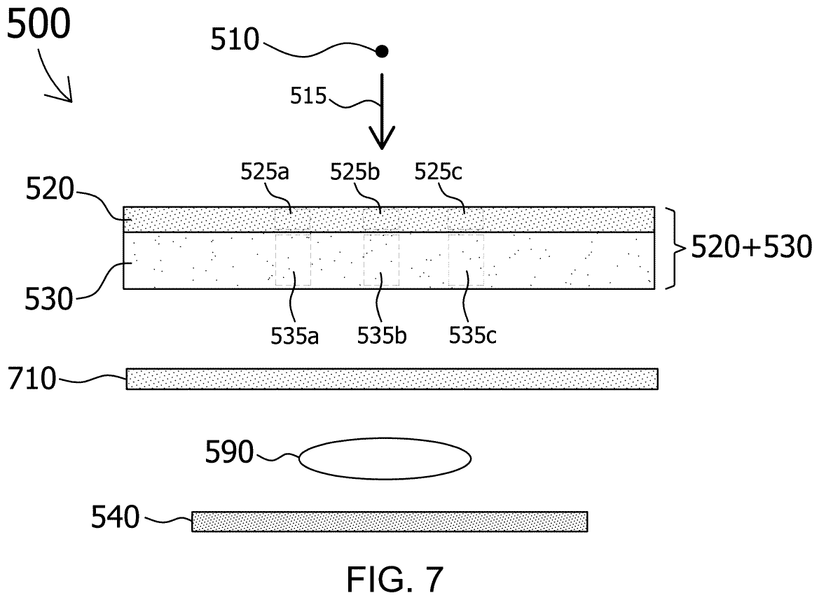

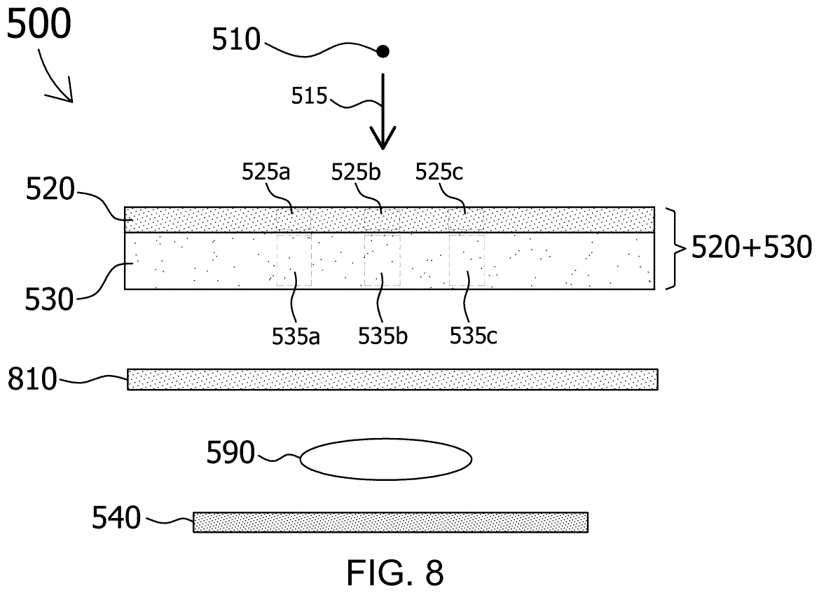

In an embodiment, with reference to FIG. 7, the imaging system 500 may include a filter layer 710 positioned between the target structure 520+530 and the X-ray detector 540. In an embodiment, the filter layer 710 may block the first, second, and third support X-rays. As a result, the first, second, and third images of the object 590 are captured by the X-ray detector 540 not based on any interaction between the first, second, and third support X-rays and the object 590.

In an embodiment, the filter layer 710 may attenuate the first, second, and third target X-rays and the first, second, and third support X-rays by different degrees. For example, the filter layer 710 may attenuate the first, second, and third target X-rays by 50% and attenuate the first, second, and third support X-rays by 100% (i.e., block entirely).

### Grating

In an embodiment, with reference to FIG. 8, the imaging system 500 may include a grating 810 positioned between the target structure 520+530 and the X-ray detector 540. In an embodiment, the grating 810 may aim the first, second, and third target X-rays at the X-ray detector 540, and aim the first, second, and third support X-rays not at the X-ray detector 540. As a result, the first, second, and third images of the object 590 are captured by the X-ray detector 540 not based on any interaction between the first, second, and third support X-rays and the object 590.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A system, comprising:
an electron source configured to generate an electron beam;
a support layer comprising M holes (holes (i), i=1, . . . , M), with M being a positive integer; and
a target layer (A) on the support layer, and (B) comprising M target regions (target regions (i), i=1, . . . , M),
wherein for each value of i and one value of i at a time, the electron source is configured to direct the electron beam at the target region (i), thereby causing the target region (i) to generate X-rays (i) from the target region (i), while the electron beam goes through the support layer via the hole (i) without hitting any portion of the support layer.

2. The system of claim 1, further comprising an X-ray detector, wherein for each value of i, the X-ray detector is configured to capture an image (i) of a same object based on an interaction between the X-rays (i) and the object.

3. The system of claim 1, wherein M>1.

4. The system of claim 1, wherein the target layer comprises platinum, tungsten, copper, or a combination thereof.

5. The system of claim 4, wherein the target layer comprises carbon, beryllium, or a combination thereof.

6. The system of claim 1, wherein a thickness of the target layer measured in a direction perpendicular to the target layer is less than a mean free path of electrons of the electron beam in the target layer.

7. The system of claim 1, wherein the support layer comprises silicon.

8. The system of claim 1, wherein the target layer is in direct physical contact with the support layer.

9. A method of using the system of claim 1, the method comprising, for each value of i and one value of i at a time:
directing the electron beam at the target region (i), thereby causing the target region (i) to generate the X-rays (i) from the target region (i); and
capturing with a same X-ray detector an image (i) of a same object based on an interaction between the X-rays (i) and the object,
while the electron beam goes through the support layer via the hole (i) without hitting any portion of the support layer.

10. A system, comprising:
an electron source configured to generate an electron beam;
a support layer comprising M support regions (support regions (i), i=1, . . . , M), with M being a positive integer;
a target layer (A) on the support layer, and (B) comprising M target regions (target regions (i), i=1, . . . , M); and
an X-ray detector,
wherein for each value of i and one value of i at a time,
the electron source is configured to direct the electron beam simultaneously at (A) the target region (i), thereby causing the target region (i) to generate target X-rays (i) from the target region (i), and (B) the support region (i), thereby causing the support region (i) to generate support X-rays (i) from the support region (i), and
the X-ray detector is configured to capture an image (i) of a same object (A) based on an interaction between the target X-rays (i) and the object and (B) not based on any interaction between the support X-rays (i) and the object.

11. The system of claim 10, wherein the X-ray detector is configured to not detect the support X-rays (i), i=1, . . . , M.

12. The system of claim 10, further comprising a filter layer (A) positioned between the support layer and the X-ray detector and (B) configured to block the support X-rays (i), i=1, . . . , M.

13. The system of claim 10, further comprising a filter layer (A) positioned between (i) a combination of the target layer and the support layer, and (ii) the X-ray detector, and (B) configured to attenuate the target X-rays (i), i=1, . . . , M and the support X-rays (i), i=1, . . . , M by different degrees.

14. The system of claim 10, further comprising a grating (A) positioned between (i) a combination of the target layer and the support layer, and (ii) the X-ray detector, (B) configured to aim the target X-rays (i), i=1, . . . , M at the X-ray detector, and (C) configured to aim the support X-rays (i), i=1, . . . , M not at the X-ray detector.

15. The system of claim 10, wherein the support layer is configured to block a wavelength range of the target X-rays (i), i=1, . . . , M.

16. The system of claim 10, wherein
(A) the target layer comprises platinum, and the support layer comprises aluminum, or
(B) the target layer comprises copper, and the support layer comprises nickel.

17. The system of claim 16, wherein the target layer comprises a polymer.

18. The system of claim 10, wherein a thickness of the target layer measured in a direction perpendicular to the target layer is less than a mean free path of electrons of the electron beam in the target layer.

19. The system of claim 10, wherein the target layer is in direct physical contact with the support layer.

20. A method of using the system of claim 10, the method comprising, for each value of i and one value of i at a time:
directing the electron beam at the target region (i), thereby causing the target region (i) to generate the target X-rays (i) from the target region (i); and
capturing with the X-ray detector the image (i) of the object based on an interaction between the target X-rays (i) and the object.
